(19) United States
(12) Patent Application Publication
(10) Pub. No.: US 2014/0176281 A1
(43) Pub. Date: Jun. 26, 2014

(54) ELECTROMAGNETIC INDUCTION MODULE FOR WIRELESS CHARGING ELEMENT AND METHOD OF MANUFACTURING THE SAME

(71) Applicant: SAMSUNG ELECTRO-MECHANICS CO., LTD., Suwon (KR)

(72) Inventors: Chang Ryul JUNG, Suwon (KR); Dong Hyeok CHOI, Suwon (KR); Sung Yong AN, Suwon (KR)

(73) Assignee: SAMSUNG ELECTRO-MECHANICS CO., LTD., Suwon (KR)

(21) Appl. No.: 13/888,945

(22) Filed: May 7, 2013

(30) Foreign Application Priority Data
Dec. 21, 2012 (KR) 10-2012-0151010

(51) Int. Cl. H01F 27/28

(52) U.S. Cl. CPC H01F 27/2804
USPC 336/200; 29/606

(57) ABSTRACT

There is provided an electromagnetic induction module for a wireless charging element, including a laminate formed by laminating magnetic sheets, each magnetic sheet including magnetic particles and having a groove portion of a coil pattern formed in one surface thereof, and a coil disposed in the groove portion.

### CROSS-REFERENCE TO RELATED APPLICATIONS

This application claims the priority of Korean Patent Application No. 10-2012-0151010 filed on Dec. 21, 2012, in the Korean Intellectual Property Office, the disclosure of which is incorporated herein by reference.

### BACKGROUND OF THE INVENTION

1. Field of the Invention

The present invention relates to an electromagnetic induction module for a wireless charging element allowing for a reduction in a thickness of a wireless charging element and improving charging efficiency, and a method of manufacturing the same.

2. Description of the Related Art

In general, an electromagnetic induction-type wireless charging principle includes a system in which a magnetic field induced in a wireless charging module by an AC current generates induced electromotive force in coils inserted into communication devices such as smartphones and secondary batteries is charged with the generated induced electromotive force.

Wireless charging efficiency is determined based on variations in magnetic flux changed on an hourly basis, according to Faraday's Law.

In general mobile devices, a space in which a wireless charging module is mounted may be in the vicinity of a battery, such that efficiency of a wireless charging system may be reduced due to a battery.

In order to solve the above limitation, a magnetic sheet is used to prevent the efficiency of the wireless charging system from being reduced due to a battery.

According to a wireless charging method according to the related art, charging is undertaken using an electromagnetic induction method in a system including a transmitter and a receiver, and in this case, the receiver includes a coil and a magnetic sheet separated from each other, and the coil and the magnetic sheet are bonded to each other by an adhesive layer.

However, a wireless charging element may be relatively thick and space efficiency thereof may be degraded, due to the adhesive layer.

As a result, in order to reduce the thickness of a wireless charging element and increase charging efficiency thereof, demand for an improvement in the magnetic sheet has been steadily increasing.

Patent Document 1, the following related art document, discloses a wireless charging sheet including a magnetic sheet, an adhesive layer, and a coil, but does not disclose a structure in which a groove portion is formed in a sheet, as in the case of the present invention.

### RELATED ART DOCUMENT

### (Patent Document 1) Korean Patent Laid-Open Publication No. 10-2009-0113418

### SUMMARY OF THE INVENTION

An aspect of the present invention provides an electromagnetic induction module for a wireless charging element allowing for a reduction in a thickness of a wireless charging element and improving charging efficiency, and a method of manufacturing the same.

According to an aspect of the present invention, there is provided an electromagnetic induction module for a wireless charging element, including: a laminate formed by laminating magnetic sheets, each magnetic sheet including magnetic particles and having a groove portion of a coil pattern formed in one surface thereof; and a coil disposed in the groove portion.

The laminate may have a thickness of 0.1 mm to 0.5 mm.

The laminate may have a thickness of 0.25 mm to 0.5 mm.

The electromagnetic induction module for a wireless charging element may further include conductive vias electrically connecting the coil disposed in the respective different magnetic sheets.

The magnetic particles may include at least one of a metal powder, metal flakes, and ferrite.

The metal powder and the metal flakes may include at least one selected from a group consisting of iron (Fe), an iron-silicon (Fe—Si) alloy, an iron-silicon-aluminum (Fe—Si—Al) alloy, an iron-silicon-chromium (Fe—Si—Cr) alloy, and a nickel-iron-molybdenum (Ni—Fe—Mo) alloy.

The ferrite may include nickel-zinc-copper (Ni—Zn—Cu) or manganese-zinc (Mn—Zn).

According to another aspect of the present invention, there is provided a method of manufacturing an electromagnetic induction module for a wireless charging element, the method including: preparing a plurality of magnetic green sheets using a paste including magnetic particles; forming a groove portion of a coil pattern in one surface of the respective magnetic green sheets; forming magnetic sheets by sintering the magnetic green sheets; disposing a coil in the groove portion; forming conductive vias electrically connecting the coil disposed in the respective different magnetic sheets; and forming a laminate by laminating the magnetic sheets.

The laminate may have a thickness of 0.1 mm to 0.5 mm.

The laminate may have a thickness of 0.25 mm to 0.5 mm.

The magnetic particles may include at least one of a metal powder, metal flakes, and ferrite.

The metal powder and the metal flakes may include at least one selected from a group consisting of iron (Fe), an iron-silicon (Fe—Si) alloy, an iron-silicon-aluminum (Fe—Si—Al) alloy, an iron-silicon-chromium (Fe—Si—Cr) alloy, and a nickel-iron-molybdenum (Ni—Fe—Mo) alloy.

The ferrite may include nickel-zinc-copper (Ni—Zn—Cu) or manganese-zinc (Mn—Zn).

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an exploded perspective view illustrating an electromagnetic induction module for a wireless charging element according to an embodiment of the present invention;

FIG. 2 is a perspective view illustrating the electromagnetic induction module for a wireless charging element according to the embodiment of the present invention;

FIG. 3 is a cross-sectional view taken along line A-A′ of FIG. 2;

FIG. 4 is a process diagram illustrating a method of manufacturing a magnetic sheet according to an embodiment of the present invention;

FIG. 5 is a cross-sectional view schematically illustrating a wireless charging element according to another embodiment of the present invention; and

FIG. 6 is a graph illustrating wireless charging efficiency in accordance with a thickness of the electromagnetic induction module for a wireless charging element according to Inventive Example of the present invention and wireless charging efficiency in accordance with a thickness of an electromagnetic induction module for a wireless charging element according to Comparative Example.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

Meanwhile, in describing the embodiment of the present invention, a wireless charging element may be comprehensively referred to as a wireless power transmitting device that transmits power and a wireless power receiving device that receives and stores power.

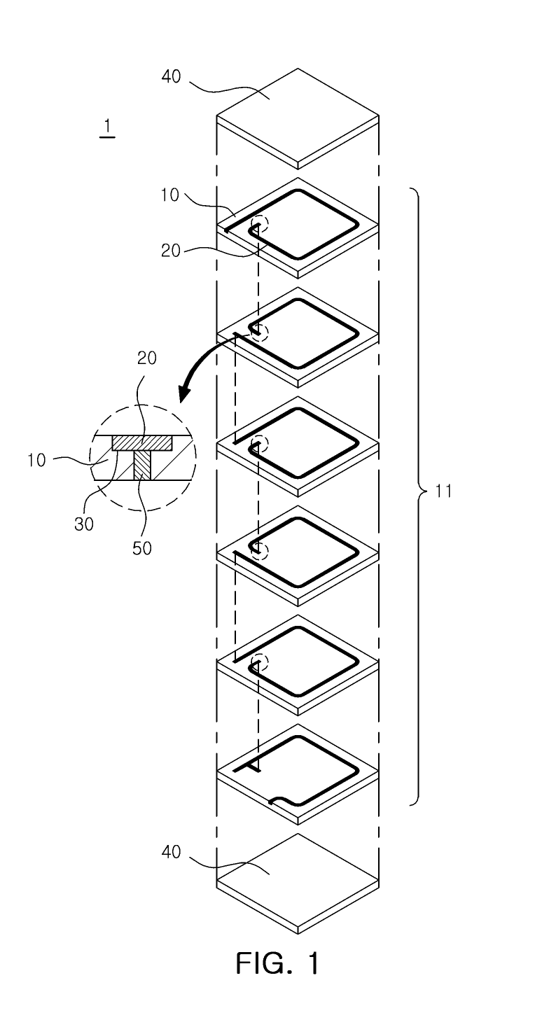

FIG. 1 is an exploded perspective view illustrating an electromagnetic induction module for a wireless charging element according to an embodiment of the present invention.

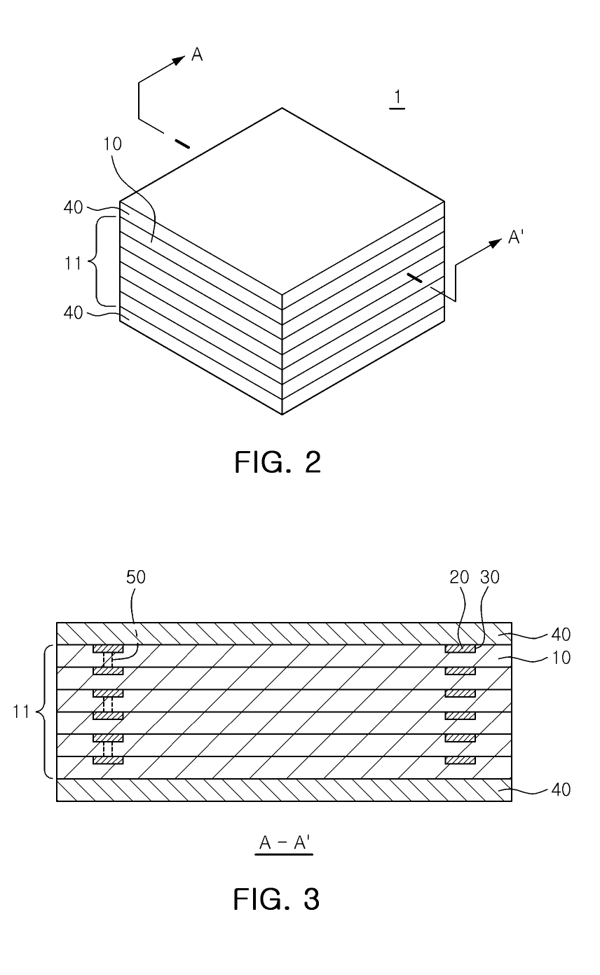

FIG. 2 is a perspective view illustrating the electromagnetic induction module for a wireless charging element according to the embodiment of the present invention.

FIG. 3 is a cross-sectional view taken along line A-A′ of FIG. 2.

Referring to FIGS. 1 through 3, the embodiment of the present invention provides an electromagnetic induction module 1 for a wireless charging element including: a laminate 11 having at least two magnetic sheets 10 laminated therein, each magnetic sheet 10 including a groove portion 30; and a coil 20 disposed in the groove portion 30.

The groove portion 30, a space having the coil 20 disposed therein, may have a shape corresponding to a pattern shape of the coil 20.

Unlike a method of bonding the magnetic sheet and the coil that are separated from each other by an adhesive layer according to the related art, the coil 20 may be directly formed on the magnetic sheet 10 to reduce the thickness of the wireless charging element.

Further, according to the embodiment, the groove portion 30 is formed in the magnetic sheet 10 and the coil 20 is disposed in the groove portion 30, whereby the thickness of the wireless charging element may be further reduced and wireless charging efficiency may be improved, as compared with the case using a method of disposing the coil 20 without forming the groove portion 30 in the magnetic sheet 10.

The reason for this is that in an overall thickness of the module, a thickness ratio of the magnetic sheets 10 is increased in the case that the groove portion 30 is formed in the magnetic sheets 10 and the coil 20 is disposed in the groove portion 30, as compared to the case in which the groove portion 30 is not formed in the magnetic sheets 10 and the coil 20 is formed on the magnetic sheets 10, when the electromagnetic induction module is manufactured to have the same thickness in both cases.

In addition, the electromagnetic induction module 1 for a wireless charging element according to the embodiment of the present invention is formed by laminating a plurality of the magnetic sheets 10. In this case, the coil 20 is not coplanarly disposed, and is arranged on different magnetic sheets 10 to be connected by conductive vias 50.

As compared with the case in which a two-dimensional coil (arranged on the same magnetic sheet) is formed, resistance occurring due to a density of the coil may be reduced in the case in which a three-dimensional coil (a coil disposed on different magnetic sheets and then connected by conductive vias) is formed, when the total amount of turns is equal in both cases.

Therefore, the embodiment of the present invention may provide the electromagnetic induction module 1 in which the number of laminations of the magnetic sheets 10 is controlled, such that a significantly high level of induced magnetic field is formed while having low resistance.

The magnetic sheets 10 may include magnetic particles and the magnetic particles may include at least one of a metal powder, metal flakes, and ferrite.

The metal powder and the metal flakes may include at least one selected from a group consisting of iron (Fe), an iron-silicon (Fe—Si) alloy, an iron-silicon-aluminum (Fe—Si—Al) alloy, an iron-silicon-chromium (Fe—Si—Cr) alloy, and a nickel-iron-molybdenum (Ni—Fe—Mo) alloy, but are not limited thereto.

The ferrite may include at least one of nickel-zinc-copper (Ni—Zn—Cu) and manganese-zinc (Mn—Zn), but is not limited thereto.

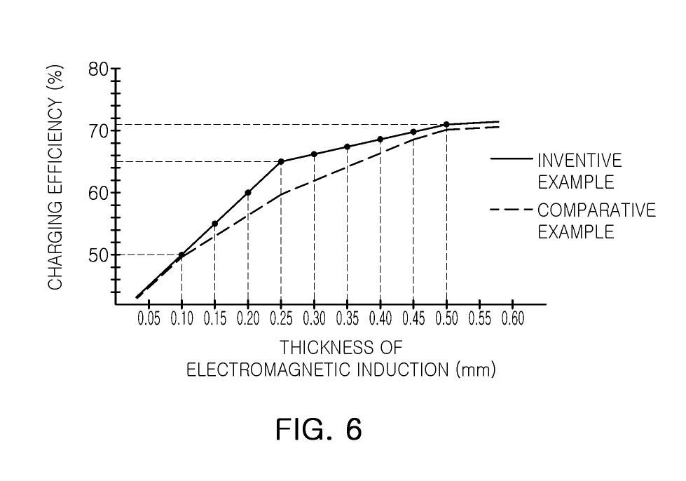

FIG. 6 is a graph illustrating wireless charging efficiency in accordance with a thickness of the electromagnetic induction module for a wireless charging element according to Inventive Example of the present invention and wireless charging efficiency in accordance with a thickness of an electromagnetic induction module for a wireless charging element according to Comparative Example.

According to the embodiment of the present invention, the electromagnetic induction module 1 for a wireless charging element may have a thickness of 0.1 mm to 0.5 mm.

When the thickness of the electromagnetic induction module 1 is 0.5 mm or less, the electromagnetic induction module may have commerciality as a configuration of the wireless charging element, while when the thickness thereof exceeds 0.5 mm, a difference in terms of charging efficiency is rarely present in the electromagnetic induction module as compared with the case in which the groove portion is not formed and the coil is independently formed on the magnetic sheet (Comparative Example of FIG. 6). Further, when the thickness of the electromagnetic induction module 1 is less than 0.1 mm, a magnetic field absorption effect is lowered and accordingly, the charging efficiency is below 50%, such that the electromagnetic induction module 1 does not function appropriately as a wireless charging component and has little difference in terms of charging efficiency as compared with the case in which the magnetic sheet and the coil are formed separately (Comparative Example of FIG. 6).

Further, as illustrated in FIG. 6, it can be appreciated that an increasing rate of charging efficiency is reduced at a point at which the thickness of the electromagnetic induction module 1 is 0.25 mm, as a boundary. That is, when the thickness of the electromagnetic induction module 1 is less than 0.25 mm, a thickness ratio of the magnetic sheet to the coil in the electromagnetic induction module is rapidly increased and therefore, charging efficiency is sharply increased, and the thickness ratio of the magnetic sheet to the coil is maintained to have a predetermined level when the thickness of the electromagnetic induction module 1 is 0.25 mm or greater, such that the charging efficiency is smoothly increased even when the thickness of the electromagnetic induction module is increased.

Therefore, the thickness of the electromagnetic induction module 1 may be in a range of 0.25 mm and 0.5 mm, in which the effect of forming the groove portion in the magnetic sheet and disposing the coil in the groove portion according to the embodiment of the present invention is most significantly shown.

The coil 20 is formed in the groove portion 30 of the magnetic sheet 10, such that a further increase in thickness due to the coil may not be generated. Therefore, the thickness of the electromagnetic induction module 1 according to the embodiment of the present invention may be equal to a thickness of the laminate 11, and the thickness of the laminate 11 may be 0.5 mm or less.

The pattern shape of the coil 20 is not limited thereto, but may be a circular shape, a rectangular shape or the like, and the pattern shape of the coil 20 for wireless charging may be varied to have other shapes.

The coil 20 has a magnetic circuit formed therein to transmit a magnetic field induced by an input current or receive the induced magnetic field to generate an induced current, thereby enabling wireless (contactless) power transmission.

Generally, when the electromagnetic induction module 1 is used in a wireless charging element, the electromagnetic induction module 1 needs to be repeatedly bonded to or separated from a flat surface, a curved surface, or an uneven surface. Therefore, flexibility may be provided through half-cutting.

In a half-cutting process, a groove is formed in a sheet so as to have a depth equal to half or less of a sheet thickness, and the groove may be formed in a flat surface in a matrix pattern form. However, the groove may be varied in other pattern forms, without being limited thereto.

The groove may be a U-shaped groove or a V-shaped groove, and the shape of the groove may be appropriately selected according to the intended purpose thereof.

Further, a cover sheet 40 on which the coil is not formed may be further disposed on an upper surface, a lower surface, or both surfaces of the laminate 11 and may be formed of the same material as the magnetic sheets 10 included in the laminate 11.

A method of manufacturing the electromagnetic induction module 1 for a wireless charging element according to an embodiment of the present invention includes; preparing a plurality of magnetic green sheets using paste including magnetic particles; forming the groove portion 30 having a pattern shape of the coil 20 in one surface of the respective magnetic green sheets; forming the magnetic sheets 10 by sintering the magnetic green sheets; disposing the coil 20 in the groove portion 30; forming the conductive vias 50 electrically connecting the coil 20 disposed in the groove portion 30 of the respective different magnetic sheets 10; and forming the laminate 11 by laminating a plurality of the magnetic sheets 10.

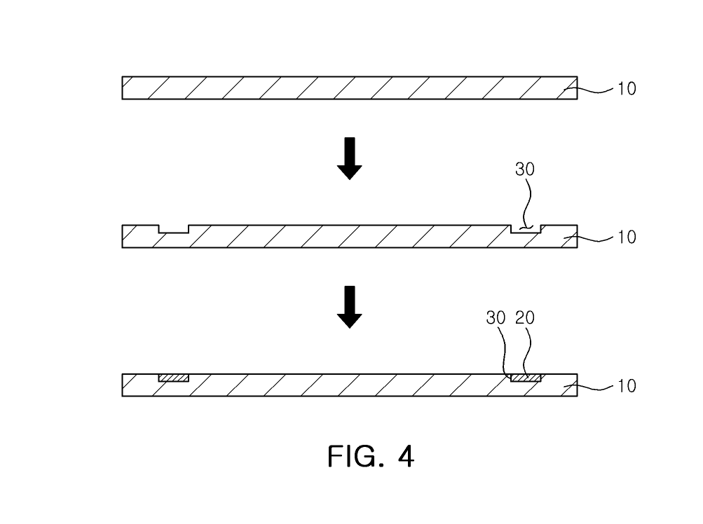

FIG. 4 is a process diagram illustrating the disposing of the coil on the magnetic sheets.

Meanwhile, the green sheets may be manufactured in sheet forms using a tape casting process, and the like by mixing the magnetic particles having compositions for achieving desired characteristics with a binder and a molding solvent. However, the method of manufacturing green sheets is not limited thereto, and therefore any method able to handle sintering of magnetic particles may be used without being limited.

The paste used for forming a green sheet may be prepared by mixing magnetic particles having an appropriate composition and including at least one of a metal powder, metal flakes and ferrite with a binder resin and adding a volatile solvent thereto so as to control viscosity.

The volatile solvent is not limited thereto, but may include at least one of toluene, alcohol, and methyl ethyl ketone (MEK).

The binder may be at least one selected from a group consisting of water glass, polyimide, polyamide, silicon, phenol resin, and an acrylic, but is not limited thereto.

A ceramic powder may be further added to the paste if the paste needs to have insulating properties, and the ceramic powder may include kaolin, talc, and the like, but any material having electrical insulating properties may be used without being limited thereto.

Next, the groove portion 30 may be formed in the respective green sheets in order to dispose the coil 20 therein by a method such as laser etching, and the like.

The magnetic sheets 10 may be formed by finally sintering the green sheets.

In the method of disposing the coil 20, a conductive paste may be disposed in the groove portion 30 using a silkscreen process, an inkjet process, and the like, or a plasma process for direct coating and low-temperature thermal treatments may be performed on the disposed conductive paste to thereby convert the conductive paste into the coil 20 having conductivity.

Alternatively, a metal may be directly disposed in the groove portion 30 through a plating process without using the conductive paste, in addition to the process, any method of forming the coil 20 in the groove portion 30 may be used without being limited.

Further, the conductive vias 50 penetrating through the magnetic sheets 10 is formed in positions at which the coil 20 is disposed and the magnetic sheets 10 are laminated to electrically connect the coil 20 disposed in the different magnetic sheets 10.

After the forming of the laminate 11 by laminating the plurality of magnetic sheets 10 in which the coil 20 and the conductive vias 50 are formed, a method of increasing compactness by applying pressure to the laminate 11.

Further, the cover sheet 40 on which the coil is not formed may be further disposed on the upper surface, the lower surface, or both surfaces of the laminate 11 and may be formed of the same material as that of the magnetic sheets 10 included in the laminate 11.

In order to avoid overlapped descriptions, descriptions of elements overlapped with the above-described electromagnetic induction module 1 for the wireless charging element according to the embodiment of the present invention will be omitted, in a description of the method of manufacturing of the electromagnetic induction module for the wireless charging element.

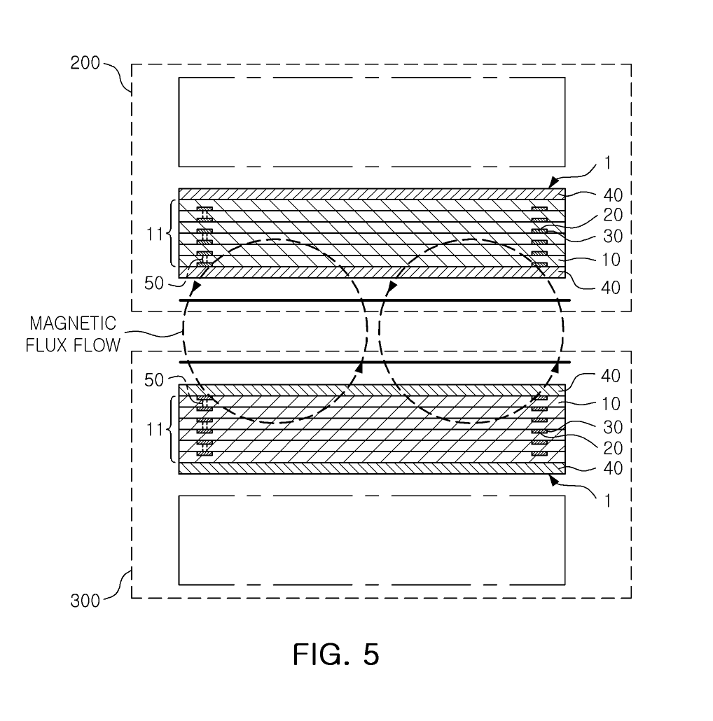

FIG. 5 is a cross-sectional view schematically illustrating a wireless charging element according to another embodiment of the present invention.

Referring to FIG. 5, the wireless charging element includes a wireless charging transmitter 100 and a wireless charging receiver 200. Each of the wireless charging receiver 100 and the wireless charging receiver 200 may include the electromagnetic induction module 1 for a wireless charging element, including the laminate 11 having the magnetic sheets 10 laminated therein, each magnetic sheet 10 including magnetic particles and having the groove portion 30 of a coil pattern in one surface thereof; and the coil 20 disposed in the groove portion 30.

When AC voltage is applied to the coil 20 of the wireless charging transmitter 100, the magnetic field around the coil 20 is changed and the magnetic field around the coil 20 of the wireless charging receiver 200 adjacently disposed to the wireless charging transmitter 100 is changed accordingly.

The coil 20 of the wireless charging receiver 200 may transmit voltage according to the change in magnetic field in the coil 20 of the wireless charging receiver 200.

As set forth above, according to the embodiments of the present invention, the electromagnetic induction module for a wireless charging element allowing for a reduction in a thickness of a wireless charging element and improving charging efficiency, and the method of manufacturing the same, can be provided.

While the present invention has been shown and described in connection with the embodiments, it will be apparent to those skilled in the art that modifications and variations can be made without departing from the spirit and scope of the invention as defined by the appended claims.

What is claimed is:

1. An electromagnetic induction module for a wireless charging element, comprising:
a laminate formed by laminating magnetic sheets, each magnetic sheet including magnetic particles and having a groove portion of
a coil pattern formed in one surface thereof; and
a coil disposed in the groove portion.

2. The electromagnetic induction module of claim 1, wherein the laminate has a thickness of 0.1 mm to 0.5 mm.

3. The electromagnetic induction module of claim 1, wherein the laminate has a thickness of 0.25 mm to 0.5 mm.

4. The electromagnetic induction module of claim 1, further comprising: a conductive via electrically connecting the coil disposed in the respective different magnetic sheets.

5. The electromagnetic induction module of claim 1, wherein the magnetic particles include at least one of a metal powder, metal flakes, and ferrite.

6. The electromagnetic induction module of claim 4, wherein the metal powder and the metal flakes include at least one selected from a group consisting of iron (Fe), an iron-silicon (Fe—Si) alloy, an iron-silicon-aluminum (Fe—Si—Al) alloy, an iron-silicon-chromium (Fe—Si—Cr) alloy, and a nickel-iron-molybdenum (Ni—Fe—Mo) alloy.

7. The electromagnetic induction module of claim 4, wherein the ferrite includes nickel-zinc-copper (Ni—Zn—Cu) or manganese-zinc (Mn—Zn).

8. A method of manufacturing an electromagnetic induction module for a wireless charging element, comprising:
preparing a plurality of magnetic green sheets using a paste including magnetic particles;
forming a groove portion of a coil pattern in one surface of the respective magnetic green sheets;
forming magnetic sheets by sintering the magnetic green sheets;
disposing a coil in the groove portion;
forming a conductive via electrically connecting the coil disposed in the respective different magnetic sheets; and
forming a laminate by laminating the magnetic sheets.

9. The method of claim 8, wherein the laminate has a thickness of 0.1 mm to 0.5 mm.

10. The method of claim 8, wherein the laminate has a thickness of 0.25 mm to 0.5 mm.

11. The method of claim 8, wherein the magnetic particles include at least one of a metal powder, metal flakes, and ferrite.

12. The method of claim 11, wherein the metal powder and the metal flakes include at least one selected from a group consisting of iron (Fe), an iron-silicon (Fe—Si) alloy, an iron-silicon-aluminum (Fe—Si—Al) alloy, an iron-silicon-chromium (Fe—Si—Cr) alloy, and a nickel-iron-molybdenum (Ni—Fe—Mo) alloy.

13. The method of claim 11, wherein the ferrite includes nickel-zinc-copper (Ni—Zn—Cu) or manganese-zinc (Mn—Zn).
